(19) United States
(12) Patent Application Publication
(10) Pub. No.: US 2016/0016107 A1
(43) Pub. Date: Jan. 21, 2016

(54) Filtering Device For Self-Propulsion Gas Systems

(71) Applicant: Emer S.p.A., Eufemia (IT)

(72) Inventors: Roberto Defilippi, Botticino (IT); Giulia Omesti, Botticino (IT)

(21) Appl. No.: 14/717,949

(22) Filed: May 20, 2015

Related U.S. Application Data
(63) Continuation of application No. PCT/IB2013/060240, filed on Nov. 19, 2013.

(30) Foreign Application Priority Data
Nov. 21, 2012 (IT) BS2012A000163

(51) Int. Cl. B01D 53/04; F02M 61/16; B01D 46/24

(52) U.S. Cl. CPC B01D 53/0407; B01D 46/2418; F02M 61/165

(57) ABSTRACT

A gas filtering device for a self-propulsion gas system includes a gas inlet duct, a gas outlet duct, a first passive filtering element, for example a microfiber cartridge, and a second active filtering element, such as activated carbon, fluidly connected in series to the passive filtering element along a gas path between the inlet duct and the outlet duct.

### CROSS-REFERENCE TO RELATED APPLICATIONS

This application is a continuation of International Application No. PCT/IB2013/060240 having a filing date of Nov. 19, 2013, entitled “Filtering Device For Self-Propulsion Gas Systems”, which is related to and claims priority benefits from Italian patent application No. BS2012A000163 filed on Nov. 21, 2012. This application also claims foreign priority benefits from the '163 Italian application. The '240 international application is hereby incorporated by reference herein in its entirety.

### FIELD OF THE INVENTION

The present invention relates in general to self-propulsion gas systems using compressed natural gas, liquefied petroleum gas (LPG) or other gaseous combustibles, and refers to a filtering device applied to the low pressure part of the LPG or gaseous phase methane system.

### BACKGROUND OF THE INVENTION

A self-propulsion gas system generally includes a cylinder or tank placed away from the motor (such as in the trunk of the vehicle), a pipe which connects the cylinder or tank to the motor, valve devices placed along the pipe to control the flow of gas towards the motor, at least one gas pressure regulation device, and a filter applied downstream of the pressure regulation device and upstream of the injectors.

Currently the filters used in self-propulsion gas systems downstream of the geared motor use filtering elements such as pleated paper, microfiber or other passive technologies which allow unwanted substances to reach the injectors. These contaminants obstruct the injectors causing poor functioning and deterioration of the motor.

The presence of contaminants is a known problem in LPG fuelled systems, particularly when the pressure regulator/vaporizer is low performance and the LPG in output is partially liquid. LPG in its liquid state has dissolved contaminants which are not captured by the passive filter.

What is needed is a device that prevents, or at least reduces the amount of chemical agents dissolved in the fuel, such as heavy hydrocarbons, that reach the injectors.

### SUMMARY OF THE INVENTION

In some embodiments the filtering device has a compact structure and is made with a reduced number of components and connections. The reduced number of components and connections reduces the possible points of leakage, simplifies installation and maintenance and reduces the space occupied by the filtering elements.

In some embodiments the gas fuel filtering device for a self-propulsion gas system, includes a gas inlet duct; a gas outlet duct; a passive first filtering element; and an active second filtering element fluidly connected in series to the passive filtering element along a gas path between the inlet duct and the outlet duct.

In some embodiments the first and second filtering elements are housed inside a device body having a gas inlet duct and a filtered gas outlet duct. The device body can include a first chamber in fluid communication with the inlet duct; a second chamber in fluid communication with the first chamber only through the first filtering element; and a third chamber in fluid communication with the outlet duct and in fluid communication with the second chamber only through the second filtering element.

In some embodiments the first and second filtering elements have an axial symmetric shape and are coaxial with one another. In other or the same embodiments, the gas inlet and outlet ducts extend at right angles with respect to the symmetry axes of the filters, are substantially coplanar to one another and lay on a plane above the first and the second filtering elements.

In some embodiments the first chamber has an annular shape and extends at least around the first filtering element.

In some embodiments the second filtering element is housed in a respective seat, the seat having an end connecting portion connected with an outlet extremity of the first filtering element, the second chamber being formed in the end connecting portion.

In some embodiments the third chamber is formed in a top portion of the seat of the second filtering element, the top portion being open to allow fitting/removing the second filtering element from the respective seat, the device body being provided with a closing cap of the top portion.

In some embodiments the device body comprises a lower portion wherein the first filtering element is at least partially housed, and an upper portion removably and gas-tightly connected to the lower portion, in the upper portion being formed the seat for the second filtering element and the inlet and outlet ducts, the lower portion and the upper portion jointly delimiting the first chamber.

In some embodiments the passive filtering element is a cartridge in at least one of microfiber and paper and/or the active filtering element consists of HCA (activated carbon honeycomb).

In some embodiments the filtering device includes least one of a temperature and a pressure and MAP sensor.

A self-propulsion gas system includes: a filtering device wherein the filtering device comprises: a gas inlet duct; a gas outlet duct; a passive first filtering element; and an active second filtering element fluidly connected in series to the passive filtering element along a gas path between the inlet duct and the outlet duct, a pressure reduction/regulating unit, wherein the inlet duct is fluidly connected to the pressure reduction/regulating unit; and a fuel injector, wherein the outlet duct is fluidly connected to the fuel injector.

### BRIEF DESCRIPTION OF THE DRAWINGS

FIG. 1 shows a diagram of a self-propulsion gas system.

FIG. 2 is an axial cross-section of the filtering device.

FIG. 3 is a perspective view of the filtering device fitted with a bracket for the attachment to a vehicle.

### DETAILED DESCRIPTION OF ILLUSTRATIVE EMBODIMENT(S)

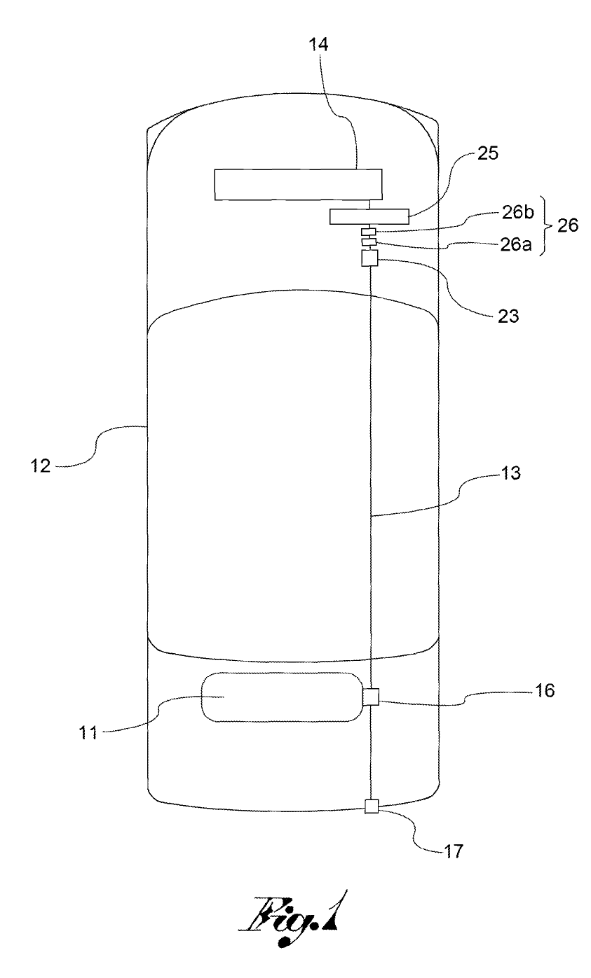

FIG. 1 schematically represents a self-propulsion gas system fitted with filtering device 26. The system comprises cylinder or tank 11 containing a high pressure gas, such as methane at approximately 220 bar or LPG in a liquid phase, placed in the rear part of vehicle 12. Tank 11 is connected by means of pipe 13 to motor 14 of vehicle 12.

The system further comprises cylinder valve 16 placed on the output of tank 11, pressure regulator 23 which reduces the pressure of the gas contained in tank 11 to a pressure suitable for powering motor 14, and filtering device 26 which is placed between pressure regulator 23 and injectors 25 of motor 14.

Filtering device 26 is composed of passive filtering element 26a (passive filtering element or first filtering element) which placed downstream of pressure regulator 23 and active filtering element 26b (active filtering element or second filtering element) which is placed downstream of passive filtering element 26a.

A passive filtering element is taken to mean, among other things, a cartridge of microfiber or paper.

An active filtering element is taken to mean, among other things, an activated carbon filter, also known as ACH (activated carbon honeycomb).

In one embodiment, an active filtering element 26b is an activated carbon filter such as the type described in U.S. Pat. No. 6,284,705 and is suitable for removing chemical agents and volatile organic compounds while maintaining the desired flow rate even with low gas pressure in input. In another embodiment, active filtering element 26b can be of the type described in WO 2008/027938 and/or WO 2008/027935, with activated carbons to absorb and retain contaminants and a selective heating system which permits the recovery of the contaminants absorbed by the activated carbons and improves the performance of the filter. In these embodiments the absorbent material is heated and cleaned and, as a result, the life of the filter is extended.

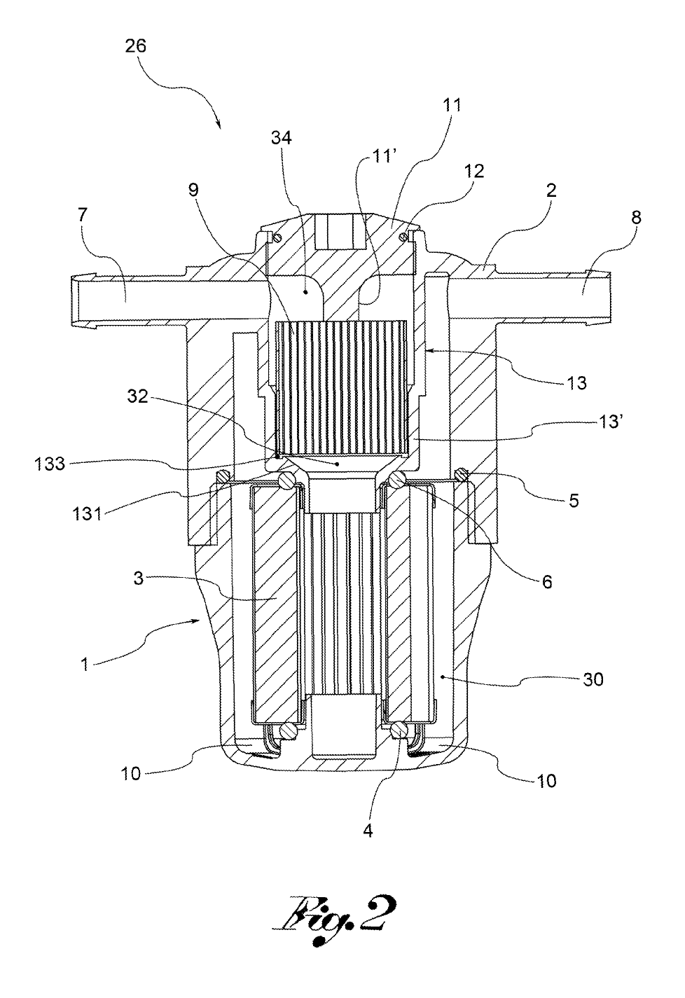

Turning to FIG. 2, gas filtering device 26 comprises first filtering element 3, which uses passive such as a microfiber cartridge. Gas filtering device 26 also includes second filtering element 9, which uses active such as activated carbon, which fluidly connected in series to first filtering element 3 along a gas path between inlet duct 8 and outlet duct 7.

First filtering element 3 and second filtering elements 9 are housed inside device body 1 along with gas inlet duct 8 and filtered gas outlet duct 7. Preferably, inlet duct 8 is connected to pressure regulator 23 and outlet duct 7 is fluidly connected to injectors 25 (see FIG. 1).

In a preferred embodiment first chamber 30 is in fluidic communication with inlet duct 8, second chamber 32 is in fluidic communication with first chamber 30 only through first filtering element 3, third chamber 34 is in fluidic communication with outlet duct 7, and third chamber 34 is in fluidic communication with second chamber 32 only through second filtering element 9.

According to one embodiment, first filtering element 3 and second filtering element 9 have an axial-symmetric shape (such as substantially cylindrical) and are coaxial with one another. In some embodiments first filtering element 3 and second filtering element 9 are placed on top of each other so their respective axes of are vertically oriented. In the same or other embodiments, second filtering element 9 is placed on top of first filtering element 3.

According to a preferred embodiment, gas inlet duct 8 and gas outlet duct 7 extend at right angles with respect to the axes of the filters. In particular, inlet duct 7 and outlet duct 8 are substantially coplanar to one another, preferably aligned with each other and with pipe 13 which connects tank 11 to motor 14. The plane on which gas inlet 8 and outlet 7 ducts lie extends above first filtering element 3 and second filtering element 8. This arrangement permits easy maintenance and facilitates the dismantling and cleaning of the filters.

According to one embodiment, first filtering element 3 is positioned on lower portion 10 of device body 1. In particular, first filtering element 3 is positioned with the interposition of lower sealing element 4, such as an O-ring, so as to snap onto the bottom of lower portion 10 of device body 1. In some embodiments, first chamber 30 is an annular shape and extends at least around first filtering element 3.

Second filtering element 9 is housed in seat 13 made in upper portion 2 of device body 1. Preferably, seat 13 is made in hollow appendage 13′ which extends from the top of device body 1 and is substantially cylindrical. Hollow appendage 13′ opens at the top and has, in a lower portion, annular abutment shoulder 133 of second filtering element 9. In addition, hollow appendage 13′ has lower connection portion 131 which connects to an outlet end of first filtering element 3.

Second chamber 32 is made in connection portion 131. More specifically, lower connection portion 131 of hollow appendage 13 ends inside the outlet end of first filtering element 3. In addition, connection portion 131 is connected to first filtering element 3 with the interposition of upper sealing element 6, such as an O-ring. Thus the gas which crosses first filtering element 3 is guided through second filtering element 9.

Third chamber 34 is made in top portion 132 of seat 13 of second filtering element 9. Top portion 132 is open and permits the insertion/extraction of second filtering element 9 from seat 13.

Device body 1 also includes closing cap 11 of top portion 132. Preferably closing cap 11 has lower projection 11′ which engages second filtering element 9 to keep second filtering element 9 in seat 13 (inside hollow appendage 13′) against annular abutment shoulder 133.

In a preferred embodiment, lower portion 10 and upper portion 2 of device body 1 are detachably connected to each other, for example by screwing, with the interposition of body sealing element 5. In some embodiments, body sealing element 5 is an O-ring. Lower portion 10 and upper portion 2 jointly define first chamber 30. Consequently first chamber 30 surrounds both first filtering element 3 and hollow appendage 13′ in which second filtering element 9 is housed. Such an embodiment uses the extension in height of the two filtering elements to make first chamber 30 and thus to limit the total space occupied by filtering device 26.

In a preferred embodiment, body 1 of filtering device 26 is made from plastic material. In other or the same embodiments, body 1 is formed of three pieces: lower portion 10, upper portion 2 and closing cover 11. Hollow appendage 13′, inlet duct 7 and outlet duct 8 can be made in one piece with upper portion 2.

Sealing element 5 is placed between lower portion 10 and upper portion 2. While sealing element 12 is placed between upper portion 2 and cover 11. This acts as an outer sealing of device 26 and prevents, or at least reduces gas leaks.

The coupling of lower part 10 to upper part 2 generates the seat of first filtering element 3, generally a cylindrical shape. The assembly of first filtering element 3 involves interposing sealing gasket 4 between first filtering element 3 and lower portion 10 and interposing sealing gasket 6 between first filtering element 3 and lower connection portion 131 of hollow appendage 13′. Sealing gaskets 4 and 6 create an inner seal, to prevent, or at least reduce, gas from flowing between first chamber 30 and second chamber 32 without passing through first filtering element 3.

First filtering element 3, of a cylindrical shape, is placed, in a preferred embodiment, coaxially to body 1.

In one embodiment, inlet and outlet ducts 8, 7 are externally molded to permit the attachment of the rubber tubes normally with low pressure gas.

The fact that first filtering element 3 is housed mainly inside lower portion 10 while second filtering element 9 is housed inside upper portion 2, simplifies dismantling in the case of maintenance, whether for the replacement of first filtering element 3 or for regenerating the activated carbon filter which can be easily extracted from above and cleaned with a jet of hot air.

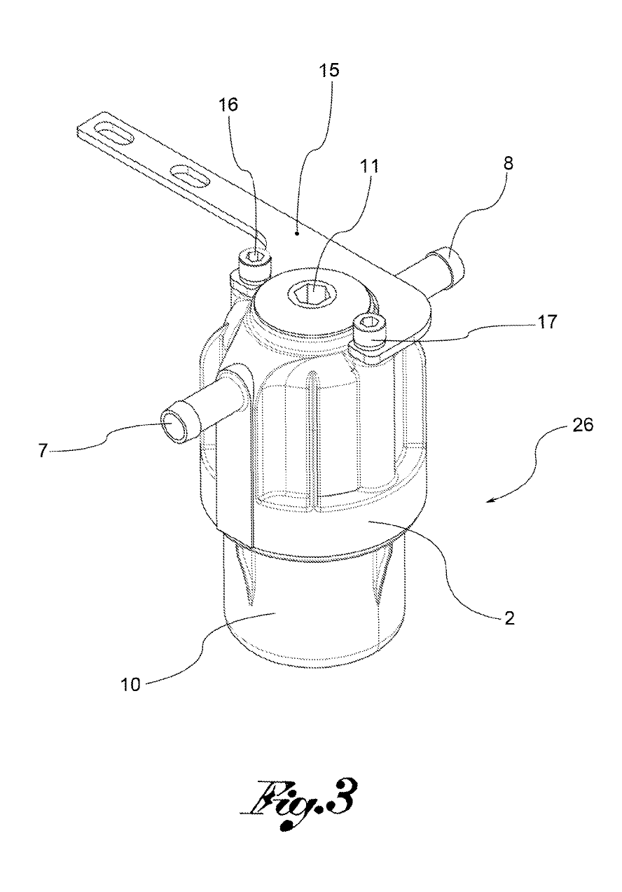

FIG. 3 shows filtering device 26 with bracket 15 attached, for example specially molded, configured for attachment of filtering device 26 to a vehicle. Bracket 15 can be attached to upper part 2 of the body of the filter via screws 16, 17, among other ways.

Filtering device 26 can be equipped with a temperature sensor, a pressure sensor and/or a MAP connection (a device configured to connect to the suction manifold that permits the pressure sensor to read the relative gas pressure with reference to the pressure/negative pressure present in the suction manifold).

Unfiltered gas containing contaminants, such as solid particles, oils, water and heavy hydrocarbons, comes from the pressure regulator, enters the filtering device and fills first chamber 30. First chamber 30 is connected with second chamber 32 via first filtering element 3 which utilizes passive technology. As a result of having gone through first filter element 3, gas present in second chamber 32 is free, or substantially free of solid particles, oils and water.

Second chamber 32 is connected with third chamber 34 and then with outlet duct 7 downstream, via second filtering element 9 which uses active, such as an activated carbon filter, to remove heavy hydrocarbons. Outlet duct 7 is in fluidic communication with the injectors. The gas that comes out from filtering device 26 free, or at least substantially free of solid particles, oils, water and heavy hydrocarbons.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A gas fuel filtering device for a self-propulsion gas system, the device comprising a gas inlet duct, a gas outlet duct, a first passive filtering element, and an active second filtering element fluidly connected in series to said passive filtering element along a gas path between said inlet duct and said outlet duct.

2. The gas fuel filtering device of claim 1, wherein said first and second filtering elements are housed inside a device body having a gas inlet duct and a filtered gas outlet duct.

3. The gas fuel filtering device of claim 2, wherein said device body comprises a first chamber in fluid communication with said inlet duct, a second chamber in fluid communication with said first chamber only through the first filtering element, and a third chamber in fluid communication with said outlet duct and in fluid communication with said second chamber only through the second filtering element.

4. The gas fuel filtering device of claim 3, wherein said first and second filtering elements have an axial symmetric shape and are coaxial with one another.

5. The gas fuel filtering device of claim 4, wherein the gas inlet and outlet ducts extend at right angles with respect to said symmetry axes of the filters, are substantially coplanar to one another and lay on a plane above the first and the second filtering elements.

6. The gas fuel filtering device of claim 4, wherein the first chamber has an annular shape and extends at least around the first filtering element.

7. The gas fuel filtering device of claim 3, wherein the second filtering element is housed in a respective seat, said seat having an end connecting portion connected with an outlet extremity of the first filtering element, the second chamber being formed in said end connecting portion.

8. The gas fuel filtering device of claim 3, wherein said third chamber is formed in a top portion of the seat of the second filtering element, said top portion being open to allow fitting/removing the second filtering element from the respective seat, the device body being provided with a closing cap of said top portion.

9. The gas fuel filtering device of claim 2, wherein said device body comprises a lower portion in which the first filtering element is at least partially housed, and an upper portion removably and gas-tightly connected to said lower portion, said upper portion having formed therein a seat for said second filtering element and said inlet and outlet ducts, said lower portion and said upper portion jointly delimiting said first chamber.

10. The gas fuel filtering device of claim 1, wherein said passive filtering element is a cartridge in at least one of microfiber and paper.

11. The gas fuel filtering device of claim 1, wherein said active filtering element consists of HCA (activated carbon honeycomb)

12. The gas fuel filtering device of claim 1, further comprising at least one of a temperature and a pressure and MAP sensor

13. A self-propulsion gas system comprising the filtering device of claim 1, wherein the inlet duct is fluidly connected to a pressure reduction/regulating unit, and wherein the outlet duct is fluidly connected to the fuel injectors.
